(19) United States
(12) Patent Application Publication
(10) Pub. No.: US 2022/0021908 A1
(43) Pub. Date: Jan. 20, 2022

(54) METHOD, DEVICE AND STORAGE MEDIUM FOR CONTROLLING LIVE BROADCAST

(71) Applicant: CCData Technology Co., Ltd., Hangzhou (CN)

(72) Inventor: Hong ZHANG, Hangzhou (CN)

(21) Appl. No.: 17/330,296

(22) Filed: May 25, 2021

(30) Foreign Application Priority Data
Jul. 16, 2020 (CN) 202010687491.7

(51) Int. Cl. H04N 21/2187; H04N 21/6377

(52) U.S. Cl. CPC H04N 21/2187; H04N 21/6377

(57) ABSTRACT

The present disclosure relates to a method, device and storage medium for controlling live broadcast, wherein the method for controlling live broadcast is applied to a server, and comprises: determining a pulley with open control authority, wherein the pulley is arranged on a track, a camera is installed on the pulley, and the camera moves along with the pulley moving on the track; determining a target audience end with the control authority of the pulley; receiving a control instruction sent by the target audience end for controlling the movement of the pulley and forwarding the control instruction to the pulley; and receiving a live broadcast picture shot by the camera and forwarding the live broadcast picture to the target audience end.

### CROSS REFERENCE TO RELATED APPLICATION

The present application claims priority to Chinese Patent Application No. 202010687491.7 filed on Jul. 16, 2020. The entire contents of the above-listed application is hereby incorporated by reference for all purposes.

### TECHNICAL FIELD

The present disclosure relates to the technical field of live broadcast, and in particular to a method, device and storage medium for controlling live broadcast and a storage medium.

### BACKGROUND

With the development of Internet technology, live video broadcast has become more and more popular. A scene of current live video broadcast is usually shot by a camera controlled by an anchor end (such as shooting angle, shooting distance and like of the camera controlled by the anchor end), thus audiences can only watch a live broadcast picture shot by the anchor end, which is increasingly unable to meet the needs of the audiences.

### SUMMARY

The object of the present disclosure mainly is to provide a method, device and storage medium for controlling live broadcast and a storage medium, which meets the requirements for the audience to control the camera for live broadcast shooting, enhances the interestingness of the live broadcast, and improves the user experience.

In order to achieve the above objective, a method for controlling live broadcast is provided according to the present disclosure, the method for controlling live broadcast may be applied to a server, the method comprising:

determining a pulley with open control authority, wherein the pulley is arranged on a track, a camera is installed on the pulley, and the camera moves along with the pulley moving on the track;

determining a target audience end with the control authority of the pulley;

receiving a control instruction sent by the target audience end for controlling movement of the pulley, and forwarding the control instruction to the pulley; and

receiving a live broadcast picture shot by the camera, and forwarding the live broadcast picture to the target audience end.

Alternatively, determining a target audience end with the control authority of the pulley comprises:

determining an audience end selected by an anchor;

determining the audience end selected by the anchor as the target audience end.

Alternatively, determining a target audience end with the control authority of the pulley comprises:

acquiring authority competition rules set by an anchor; and

determining the target audience end according to the authority competition rules.

Alternatively, after the determining a pulley with open control authority, further comprising:

sending shooting elements of the camera installed on the pulley to each audience end in a broadcasting room, so that each audience end determines whether to participate in competition of the control authority of the pulley according to the shooting elements;

determining the target audience end according to the authority competition rules, comprising:

selecting the target audience end from the audience ends participating in the competition of the control authority of the pulley according to the authority competition rules.

Alternatively, before the receiving a control instruction sent by the target audience end for controlling the pulley, and forwarding the control instruction to the pulley, further comprising:

acquiring an open time period of the control authority of the pulley set by the anchor;

receiving a control instruction sent by the target audience end for controlling the pulley, and forwarding the control instruction to the pulley, comprising:

receiving the control instruction sent by the target audience end for controlling the pulley, and forwarding the control instruction to the pulley during the open time period of the control authority.

Alternatively, the control instruction is used for controlling at least one of: a moving direction, a moving speed, a moving angle and a moving distance of the pulley.

Another method for controlling live broadcast is provided according to the present disclosure, the method for controlling live broadcast may be applied to a terminal, the method comprising:

sending by a server, a control instruction for controlling movement of a pulley to the pulley, wherein the pulley is arranged on a track, a camera is installed on the pulley, and the camera moves along with the pulley moving on the track;

receiving by the server, a live broadcast picture shot by the camera;

displaying the live broadcast picture.

A device for controlling live broadcast is provided according to the present disclosure, the device for controlling live broadcast is applied to a server, the device comprises:

a first determination module, configured to determine a pulley with open control authority, wherein the pulley is arranged on a track, a camera is installed on the pulley, and the camera moves along with the pulley moving on the track;

a second determination module, configured to determine a target audience end with the control authority of the pulley;

a first forward module, configured to receive a control instruction sent by the target audience end for controlling movement of the pulley, and forwarding the control instruction to the pulley;

a second forward module, configured to receive a live broadcast picture shot by the camera, and forwarding the live broadcast picture to the target audience end.

Alternately, the second determination module comprises:

a first determination submodule, configured to determine an audience end selected by an anchor;

a second determination submodule, configured to determine the audience end selected by the anchor as the target audience end.

Alternately, the second determination module comprises:

an acquisition submodule, configured to acquire authority competition rules set by an anchor;

a third determination submodule, configured to determine the target audience end according to the authority competition rules.

Alternately, the device further comprises:

a first sending module, configured to send shooting elements of the camera installed on the pulley to each audience end in a broadcasting room, so that each audience end determines whether to participate in competition of the control authority of the pulley according to the shooting elements;

a third determination module, specifically configured to determine the target audience end according to the authority competition rules.

Alternately, the device further comprises:

an acquisition module, configured to acquire an open time period of the control authority of the pulley set by the anchor;

the first forward module, specifically configured to receive a control instruction sent by the target audience end for controlling the pulley, and forwarding the control instruction to the pulley.

Alternately, the control instruction is used for controlling at least one of: a moving direction, a moving speed, a moving angle and a moving distance of the pulley.

A still another device for controlling live broadcast is provided according to the present disclosure, the device for controlling live broadcast may be applied to a terminal, and the device comprises:

a second sending module configured to send by a server, a control instruction for controlling movement of a pulley to the pulley, wherein the pulley is arranged on a track, a camera is installed on the pulley, and the camera moves along with the pulley moving on the track;

a receiving module, configured to receive by the server, a live broadcast picture shot by the camera;

a display module configured to display the live broadcast picture.

Another device for controlling live broadcast applied to a server is further provided according to the present disclosure, and comprises:

a memory having a computer program stored thereon; and

a processor configured to execute the computer program in the memory to implement a method for controlling live broadcast, and the method for controlling live broadcast comprises:

determining a pulley with open control authority, wherein the pulley is arranged on a track, a camera is installed on the pulley, and the camera moves along with the pulley moving on the track;

determining a target audience end with the control authority of the pulley;

receiving a control instruction sent by the target audience end for controlling movement of the pulley, and forwarding the control instruction to the pulley; and

receiving a live broadcast picture shot by the camera, and forwarding the live broadcast picture to the target audience end.

Alternately, determining a target audience end with the control authority of the pulley comprises:

determining an audience end selected by an anchor; and

determining the audience end selected by the anchor as the target audience end.

Alternately, determining a target audience end with the control authority of the pulley comprises:

acquiring authority competition rules set by an anchor; and

determining the target audience end according to the authority competition rules.

Alternately, after determining a pulley with open control authority, the method for controlling live broadcast further comprises:

sending shooting elements of the camera installed on the pulley to each audience end in a broadcasting room, so that each audience end determines whether to participate in competition of the control authority of the pulley according to the shooting elements;

determining the target audience end according to the authority competition rules, comprising:

selecting, according to the authority competition rules, the target audience end from the audience ends participating in the competition of the control authority of the pulley.

Alternately, before receiving a control instruction sent by the target audience end for controlling the pulley and forwarding the control instruction to the pulley, the method for controlling live broadcast further comprises:

acquiring an open time period of the control authority of the pulley set by the anchor; receiving a control instruction sent by the target audience end for controlling the pulley, and forwarding the control instruction to the pulley, comprises:

receiving the control instruction sent by the target audience end for controlling the pulley, and forwarding the control instruction to the pulley during the open time period of the control authority.

Alternately, the control instruction is used for controlling at least one of: a moving direction, a moving speed, a moving angle and a moving distance of the pulley.

A device for controlling live broadcast applied to terminal is provided according to the present disclosure, comprises:

a memory having a computer program stored thereon; and

a processor configured to execute the computer program in the memory to implement the steps of the above method for controlling live broadcast applied to terminal.

A computer readable storage medium having computer program instructions stored thereon is provided according to the present disclosure, the program when is executed by a processor, implement the steps of the above method for controlling live broadcast applied to server.

A computer readable storage medium having stored thereon computer program instructions is provided according to the present disclosure, the program when is executed by a processor, implement the steps of the above method for controlling live broadcast applied to terminal.

According to the above technical solution, a camera is installed on a pulley, the pulley is arranged on a track, the camera moves along with the pulley moving on the track, and control authority of the pulley is open; the technical solution comprises: determining a target audience end with the control authority of the pulley, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to embodiment of the present disclosure, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

Additional features and advantages of the present disclosure will be set forth in part in the detailed description which follows.

### BRIEF DESCRIPTION OF THE FIGURES

The drawings illustrated here provide a further understanding of the present disclosure and form a part of this description. The drawings and the detailed description below are used to explain the present disclosure without limiting the scope of the disclosure, in which:

FIG. 1 is a flowchart illustrating a method for controlling live broadcast according to an embodiment of the present disclosure.

FIG. 2 is a flowchart illustrating another method for controlling live broadcast according to an embodiment of the present disclosure.

FIG. 3 is a schematic diagram illustrating a scene of live broadcast according to an embodiment of the present disclosure.

FIG. 4 is a flowchart illustrating still another method for controlling live broadcast according to an embodiment of the present disclosure.

FIG. 5 is a schematic diagram illustrating another scene of live broadcast according to an embodiment of the present disclosure.

FIG. 6 is a flowchart illustrating still another method for controlling live broadcast according to an embodiment of the present disclosure.

FIG. 7 is a schematic diagram illustrating still another scene of live broadcast according to an embodiment of the present disclosure.

FIG. 8 is a structure diagram illustrating a device for controlling live broadcast according to an embodiment of the present disclosure.

FIG. 9 is a structure diagram illustrating another device for controlling live broadcast according to an embodiment of the present disclosure.

FIG. 10 is a structure diagram illustrating still another device of controlling live broadcast according to an embodiment of the present disclosure.

FIG. 11 is a structure diagram illustrating a device for controlling live broadcast according to an embodiment of the present disclosure.

FIG. 12 is a structure diagram illustrating another device for controlling live broadcast according to an embodiment of the present disclosure.

### DETAILED DESCRIPTION

Embodiments of the disclosure will be described hereinafter in detail in combination with the accompanying drawings. It should be understood that the specific embodiments described herein are illustrative and explanatory only and are not used to restrict to the present disclosure.

First, an application scene of the present disclosure is described, and the present disclosure may be applied to a live video scene. At present, in the live video scene, a camera is usually controlled by an anchor end to shoot a live broadcast picture, such as shooting angles, shooting distances and like of the camera are controlled by the anchor, an audience end only passively receives the live broadcast pictures, and cannot control the camera. In some cases, the audience may wish to control the camera himself to shoot live broadcast pictures, such as in a marketing scene by the live broadcast, and the audience may wish to obtain more detailed information about the product by controlling the camera himself, which is not possible in the related art.

A method for controlling live broadcast applicable to a server is provided according to the embodiment of the present disclosure, wherein the server may be a background server corresponding to a live broadcast application program. The method for controlling a live broadcast comprises: determining a pulley with open control authority, wherein the pulley is arranged on a track, a camera is installed on the pulley, and the camera moves along with the pulley moving on the track; determining a target audience end with the authority of controlling the pulley; receiving a control instruction sent by the target audience end for controlling the movement of the pulley, and forwarding the control instruction to the pulley; receiving a live broadcast picture shot by the camera, and forwarding the live broadcast picture to the target audience end. That is, a control mode for enabling an audience to control a camera to shoot a live broadcast picture is provided according to the embodiment of the present disclosure, and the audience may control movement of the pulley on the track depend to his own needs, so that the camera installed on the pulley is driven for movement, in turn controlling a shooting view angle is achieved, which meets the requirements for the audience to control the camera for live broadcast shooting, enhances the interestingness of the live broadcast, and improves the user experience.

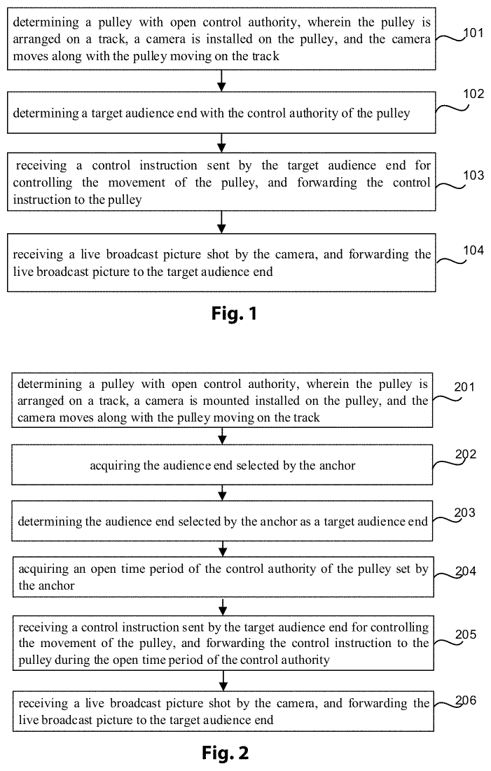

Referring to FIG. 1, FIG. 1 is a flow chart illustrating a method for controlling live broadcast applied to a server according to an embodiment of the present disclosure. As shown in FIG. 1, the method comprising the following steps:

Step 101, determining a pulley with open control authority, wherein the pulley is arranged on a track, a camera is installed on the pulley, and the camera moves along with the pulley moving on the track.

The pulley of the present embodiment may refer to a mechanical structure capable of being remotely controlled and moved or slid on a predetermined track, the shape of the predetermined track includes, but not limited to, circle, ellipse, ring, etc. Specifically, in the embodiment, the camera for shooting the live broadcast picture is installed on the pulley, and the camera is driven to move by the use of the pulley moving on the track.

In the embodiment, the pulley with the open control authority refers to a pulley which may be controlled by an audience end, one or a plurality of pulleys with the open control authority may be provided, each pulley with the open control authority may be provided with a camera for shooting the live broadcast picture, and a plurality of pulleys with the open control authority may be arranged on the same track or may be respectively arranged on different tracks, which are not specifically limited. The open control authority may be set by a user of the anchor end (such as an anchor), and a pulley with the open control authority may be controlled by an audience end.

Step 102, determining a target audience end with the authority of controlling the pulley.

For example, a number of games or activities may be set in a broadcasting room to select a target audience end from audience ends participating in the game or activity. When there are a plurality of pulleys with the open control authority, a corresponding target audience end may be determined for each pulley. In a particular embodiment, for example, there are two pulleys with the open control authority, a target audience end may be determined for each of the two pulleys.

In a specific implementation, the target audience end may be installed with a pulley control application program. After the target audience end is determined, camera position information (such as a camera position number, a camera position name and the like), authorization code information or access code information of a corresponding pulley may be sent to the target audience end, so that the target audience end establish communication connection with the corresponding pulley by the pulley control application program installed on the target audience end according to the camera position information, the authorization code information or the access code information.

Step 103, receiving a control instruction sent by a target audience end for controlling the movement of the pulley, and forwarding the control instruction to the pulley.

The target audience end may send a control instruction to the server by the pulley control application program installed on the target audience end, the server receives the control instruction sent by the target audience end and forwards the control instruction to the pulley, the control instruction is used for controlling movement of the pulley, and the camera is driven to move by the way the pulley moves, so that the shooting view angle is changed. For example, in a live broadcast process, a user (i.e. an audience) at a target audience end having authority of controlling a pulley can control the pulley to advance, retreat, rotate, etc. according to his own requirements, thereby driving the movement of the camera and achieving the goal of controlling the shooting view angle of the camera.

Step 104, receiving a live broadcast picture shot by the camera, and forwarding the live broadcast picture to the target audience end.

The live broadcast picture shot by the camera is the live broadcast picture shot under the view angle controlled by the target audience end. When the live broadcast picture shot by the camera is forwarded to the target audience end, the live broadcast picture can also be forwarded to other audience ends (i.e. audience ends without the authority of controlling the pulley) in the broadcasting room. Meanwhile, the live broadcast picture shot by the camera installed on a pulley with not open control authority (i.e. a pulley controlled by an anchor end) may also be sent to a target audience end, wherein the anchor end may also be installed with a pulley control application program to control the pulley with not open control authority by the pulley control application program, or the anchor end may control these pulleys with not open control authority by a handle or a controller.

In a specific implementation, when there are a plurality of camera positions, the server may transmit a live broadcast picture shot by a camera installed on a pulley corresponding to the position to an audience end according to the selection of the audience. For example, there are three camera positions in the broadcasting room: a camera position I, a camera position II, and a camera position III. In case that the target audience end has the authority of controlling the pulley at the camera position I, and the audience of the target audience end selects to watch the live broadcast pictures shot by the cameras installed on the pulleys at the camera position I and the camera position II, the server may simultaneously send the live broadcast pictures shot by the cameras installed on the pulleys of the camera position I and the camera position II to the target audience end; and the target audience end may switch the display of the live broadcasting pictures of the two positions or display the live broadcasting pictures of the two positions side by side on a live broadcasting interface of the target audience end.

Alternatively, in this embodiment, the fifth generation mobile communication network 5G may be used to communicate between the server and each audience end, as well as between the server and the anchor end, in order to meet the requirements of bandwidth and delay, since multichannel video transmission and position control require high bandwidth and low delay.

According to the above technical solution, a camera is installed on a pulley, the pulley is arranged on a track, the camera moves along with the pulley moving on the track, and control authority of the pulley is open; the technical solution comprises: determining a target audience end with the control authority of the pulley, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to the embodiment of the present disclosure, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

FIG. 2 is a flowchart illustrating another method for controlling live broadcast according to an embodiment of the present disclosure, the method for controlling live broadcast is applied to a server, as shown in FIG. 2, and the method comprises the following steps:

Step 201, determining a pulley with open control authority, wherein the pulley is arranged on a track, a camera is installed on the pulley, and the camera moves along with the pulley moving on the track.

In a specific implementation, the pulley with the open control authority refers to a pulley which may be controlled by an audience end, one or more pulleys with the open control authority may be arranged, and each pulley with the open control authority may be provided with a camera for shooting a live broadcast picture.

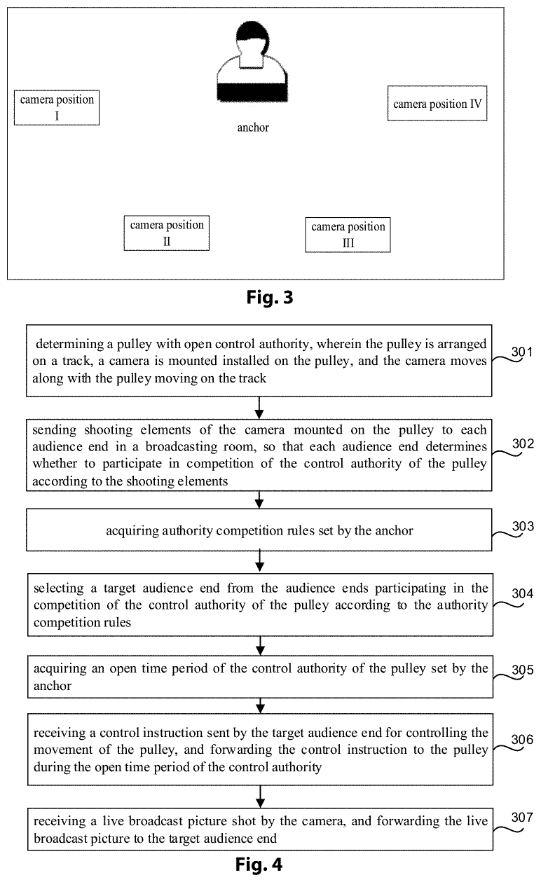

In a specific example, as shown in FIG. 3, the broadcasting room comprises a camera position I, a camera position II, a camera position III and a camera position IV, each camera position is provided with a pulley, each pulley is provided with a camera, each pulley may drive the camera installed on the pulley to move on a corresponding track, and an anchor may open the control authority of the pulleys of some or all of the four camera positions. For example, the control authority of the pulleys of the camera positions I and II may be open to the audience end, the control authority of the pulleys of the camera positions III and IV may be remained to the anchor end, and the server determines the pulleys of which the control authority is open.

Step 202, acquiring the audience end selected by the anchor.

Step 203, determining the audience end selected by the anchor as the target audience end.

For example, the anchor may select a certain audience end from the broadcasting room according to personal wishes, the server determines the audience end selected by the anchor as the target audience end. When there are a plurality of pulleys with open control authority, the anchor may select a corresponding target audience end for each of the pulleys. For example, in the above example, when the pulleys with open control authority include a pulley at the camera position I and a pulley at the camera position II, the anchor may select a target audience end for the pulley at the camera position I and the pulley at the camera position II, respectively, such as a target audience end I for the camera position I and a target audience end II for the camera position II.

In a specific implementation, the target audience end may be installed with a pulley control application program. After the target audience end is determined, the server may send camera position information (such as a position number, a position name and the like of camera), authorization code information or access code information of a corresponding pulley to the target audience end, so that the target audience end establishes communication connection with the corresponding pulley by the pulley control application program installed on the target audience end according to the camera position information, the authorization code information or the access code information.

Step 204, acquiring an open time period of the control authority of the pulley set by the anchor.

In a specific implementation, the anchor may set an open time period of the control authority of the pulley at the anchor end, and the open time periods of the control authority set for different pulleys may be the same or different; the set open time period of the control authority may be a certain time period in the live broadcasting process or the whole live broadcasting process depending on actual requirements; and the server acquires the open time period of the control authority of the pulley set by the anchor from the anchor end.

Step 205, receiving a control instruction sent by a target audience end for controlling the pulley, and forwarding the control instruction to the pulley during the open time period of the control authority.

That is, during the open time period of the control authority of the pulley, the target audience end may send a control instruction to the server by the pulley control application program installed on the target audience end, the server receives the control instruction sent by the target audience end and forwards the control instruction to the pulley, the control instruction is used for controlling movement of the pulley, and the camera is driven to move by the use of the pulley moves, so that the shooting view angle is changed.

In a specific example, for example, in a live broadcast process, a user (i.e., an audience) of a target audience end having control authority of a pulley may control at least one of: a moving direction (e.g., forward, backward), a moving speed, a moving angle (i.e., a rotating angle) and a moving distance of the pulley according to his own requirements so as to drive the camera to move and achieve the goal of controlling the shooting view angle of the camera. For example, in a marketing scene by the live broadcast, when an anchor shows a product A, the audience may adjust the camera's view angle by controlling the pulley (e.g., adjusting the angle at which the product A is shot, the distance from which the product A is shot, etc.) to more comprehensively understand the characteristics of the product A.

Step 206, receiving a live broadcast picture shot by the camera, and forwarding the live broadcast picture to the target audience end.

The live broadcast picture shot by the camera is the live broadcast picture shot under the view angle controlled by the target audience. When the live broadcast picture shot by the camera is forwarded to the target audience end, the live broadcast picture may also be forwarded to other audience ends (i.e. audience ends without the control authority of the pulley) in the broadcasting room. Meanwhile, a live broadcast picture shot by the camera installed on the pulley with not open control authority (i.e. a pulley controlled by the anchor end) also may be sent to the target audience end.

For example, in the above example, when the target audience end I is selected for the pulley at the camera position I and the target audience end II is selected for the pulley at the camera position II, in addition to sending the live broadcast pictures shot by the camera at the camera position Ito the target audience end I, the live broadcast pictures shot by the cameras at the camera positions II, III and IV may be sent to the target audience end I. Also, in addition to sending the live broadcast pictures shot by the camera at the camera position II to the target audience end II, the live broadcast pictures shot by the cameras at the camera positions I, III and IV may be sent to the target audience end II.

In a specific implementation, when there are a plurality of camera positions, the server may also send a live broadcast picture shot by a camera installed on a pulley at the corresponding camera position to an audience end according to the selection of the audience. For example, in the above example, in case that the target audience end I has the control authority of the pulley at camera position I, and the audience at the target audience end I selects to watch the live broadcast pictures shot by the cameras installed on the pulleys at the camera positions I and II, the server may simultaneously send the live broadcast pictures shot by the cameras installed on the pulleys at the camera positions I and II to the target audience end I. The target audience end I may switch the display of live broadcast pictures of the two camera positions or display the live broadcast pictures of the two camera positions side by side on a live broadcast interface of the target audience end I; and the target audience end II has the control authority of the pulley at the camera position II, and the audience at the target audience end II selects to watch the live broadcast pictures shot by the cameras installed on the pulleys of the camera positions II, III and IV, the server may simultaneously send the live broadcast pictures shot by the cameras installed on the pulleys at the camera positions II, III and IV to the target audience end II, and the target audience end II may switch the display of the live broadcast pictures of the three camera positions or display the live broadcast pictures of the three camera positions side by side on a live broadcast interface of the target audience end II.

According to the above technical solution, the camera is installed on the pulley, the pulley is arranged on the track, the camera moves along with the pulley moving on the track, the camera moves along with movement of the pulley, and control authority of the pulley is open; the technical solution comprises: determining a target audience end with the control authority of the pulley, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to the embodiment of the present disclosure, and the audience may control movement of the pulley on the track according to his own needs, so that the camera installed on the pulley is driven to move so as to control a shooting visual angle, which meets the requirements for the audience to control the camera for live broadcast shooting, enhances the interestingness of the live broadcast, enriches the interaction between the anchor and the audience, and improves the user experience.

FIG. 4 is a flowchart illustrating yet another method for controlling live broadcast according to an embodiment of the present disclosure, the method for controlling live broadcast is applied to a server, as shown in FIG. 4, and the method comprises the following steps:

Step 301, determining a pulley with open control authority, wherein the pulley is arranged on a track, a camera is installed on the pulley, and the camera moves along with the pulley moving on the track.

In a specific implementation, the pulley with the open control authority refers to a pulley which may be controlled by an audience end, one or a plurality of pulleys with the open control authority may be arranged, and each pulley with the open control authority may be provided with a camera for shooting a live broadcast picture.

Step 302, sending shooting elements of the camera installed on the pulley to each audience end in a broadcasting room, so that each audience end determines whether to participate in competition of the control authority of the pulley according to the shooting elements.

The shooting elements may refer to the main contents shot by the camera, and may be a person (e.g., an anchor) or an object (e.g., goods, articles), and is not specifically limited thereto. In this embodiment, the shooting elements of different cameras may be the same or different. The shooting elements of different cameras may be the same when the cameras installed on the pulleys at different camera positions are used for shooting the same person or object, and the shooting elements of different cameras may be different when the cameras installed on the pulleys at different positions are used for shooting different persons or objects.

As a specific example, as shown in FIG. 3, cameras at different camera positions are used to shoot the same anchor, and the elements of the cameras at different positions may be the same, both of which are the anchor. Another specific example is shown in FIG. 5. Cameras at different positions are used to shoot different anchors, wherein the cameras at the camera positions I and II are mainly used to shoot an anchor A, the shooting elements of the cameras at the camera positions I and II may be the anchor A; and the cameras at the camera positions III and IV are mainly used to shoot an anchor B, the shooting elements of the cameras at the camera positions III and IV may be an anchor B.

After receiving shooting elements of a camera installed on a pulley with open control authority, an audience end may display the shooting elements to a corresponding audience, so that the corresponding audience determines whether to participate in competition of the control authority of the pulley according to the shooting element. If the audience is interested in the shooting elements, for example, the anchor related to the shooting element is whom the audience likes, and the product related to the shooting element is the product required by the audience, the audience may participate in the competition of the control authority of the pulley by the audience end.

Step 303, acquiring authority competition rules set by an anchor.

Illustratively, the set authority competition rules are such as the audience end corresponding to the audience with the highest score/highest popularity/maximum votes/maximum reward to the anchor/maximum interaction times with the anchor has the control authority of the pulley, and the specific authority competition rules may be set according to actual requirements.

Step 304, selecting the target audience end from the audience ends participating in the competition of the control authority of the pulley according to the authority competition rules.

That is, according to the authority competition rules set by the anchor, the server may count the score/popularity/votes obtaining condition/the amount of reward given to the anchor/the times of interaction with the anchor and the like of individual audience participating in the competition, select the audience with the highest score/highest popularity/maximum votes/maximum reward to the anchor/maximum times of interaction with the anchor from the audiences participating in competition, and take the audience end corresponding to the selected audience as the target audience end.

In a specific implementation, the target audience end may be installed with a pulley control application program. After the target audience end is determined, the server may transmit position information (such as a position number, a position name and the like), authorization code information or access code information of a corresponding pulley to the target audience end, so that the target audience end establish communication connection with the corresponding pulley by the pulley control application program installed on the target audience end according to the camera position information, the authorization code information or the access code information.

Step 305, acquiring an open time period of the control authority of the pulley set by the anchor.

In the specific implementation, the anchor may set an open time period of the control authority of the pulley by the anchor end, and the open time periods of the control authority set for different pulleys may be the same or different; the set open time period of the control authority may be a certain time period in the live broadcasting process or the whole live broadcasting process depending on actual requirements; and the server acquires the open time period of the control authority of the pulley set by the anchor from the anchor end.

Step 306, receiving a control instruction sent by a target audience end for controlling the pulley, and forwarding the control instruction to the pulley during the open time period of the control authority.

That is, during the open time period of the control authority of the pulley, the target audience end may send a control instruction to the server by the pulley control application program installed on the target audience end, the server receives the control instruction sent by the target audience end and forwards the control instruction to the pulley, the control instruction is used for controlling movement of the pulley, and the pulley moves to drive the camera to move, so that the shooting view angle is changed.

Step 307, receiving a live broadcast picture shot by the camera, and forwarding the live broadcast picture to the target audience end.

The live broadcast picture shot by the camera is the live broadcast picture shot under the view angle controlled by the target audience end. When the live broadcast picture shot by the camera is forwarded to the target audience end, the live broadcast picture may also be forwarded to other audience ends (i.e. audience ends without the control authority of the pulley) in the broadcasting room. Meanwhile, a live broadcast picture shot by the camera installed on the pulley with not open control authority (i.e. a pulley controlled by the main broadcast end) also may be sent to the target audience end.

In a specific implementation, when there are a plurality of camera positions, the server may send a live broadcast picture shot by the camera installed on the pulley at the corresponding camera position to the audience end according to the selection of the audience, so that the audience at the corresponding audience end only watches the live broadcast picture shot by the camera of the camera position which the audience wants to watch for himself.

Alternatively, in this embodiment, the fifth generation mobile communication network 5G communication may be used to communicate between the server and each audience end, as well as between the server and the anchor end, in order to meet the requirements of bandwidth and delay, since multichannel video transmission and camera position control requirements of high bandwidth and low delay.

According to the above technical solution, a camera is installed on a pulley, the pulley is arranged on a track, the camera moves along with the pulley moving on the track, the camera moves along with movement of the pulley, and control authority of the pulley is open; the technical solution comprises: determining a target audience end with the control authority of the pulley by the authority competition rules set by the anchor, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to the embodiment of the present disclosure, and the audience may obtain the control authority by participating in the activity competition set by the anchor and then control movement of the pulley according to his own needs, so that the camera installed on the pulley is driven to move so as to control a shooting visual angle, which meets the requirements for the audience to control the camera for live broadcast shooting, enhances the interestingness of the live broadcast, enriches the interaction between the anchor and the audience, and improves the user experience.

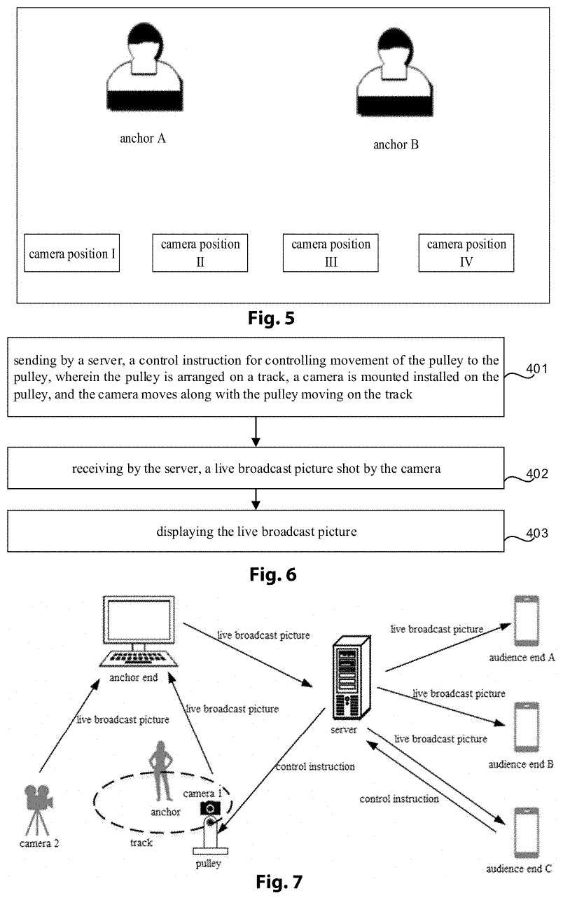

FIG. 6 is a flow chart illustrating yet another method for controlling live broadcast applied to a terminal according to an embodiment of the present disclosure, the terminal may be an audience's mobile equipment, such as a tablet computer, a smart phone, a smart television, a PDA (Personal Digital Assistant), a portable computer and the like, or may be fixed equipment, such as a desktop computer and the like, as shown in FIG. 6, and the method comprises the following steps:

Step 401, sending by a server, a control instruction for controlling movement of the pulley to the pulley, wherein the pulley is arranged on a track, a camera is installed on the pulley, and the camera moves along with the pulley moving on the track.

The audience end of the present embodiment is an audience end with the control authority of the pulley determined by the server, and the method for specifically determining the audience end with the control authority of the pulley may be described with reference to the above embodiment and will not be described in detail herein. The audience end may be installed with a pulley control application program. After the server determines to open the control authority of the pulley to the audience end, the audience end may receive camera position information (such as a camera position number, a camera position name and the like), authorization code information or access code information of the pulley sent by the server. According to the camera position information, the authorization code information or the access code information, communication connection is established with the corresponding pulley by the pulley control application program installed on the audience end, and a control instruction for controlling the movement of the pulley is sent to the pulley by the established communication connection.

Step 402, receiving by the server, a live broadcast picture shot by the camera.

The live broadcast picture shot by the camera is a live broadcast picture shot under the control view angle of the audience end. When the live broadcast picture shot by the camera is received, the live broadcast pictures shot by the cameras installed on the other pulleys with not open control authority (i.e. the pulleys controlled by the anchor end) may also be received. Other pulleys with not open control authority may be controlled to move on the track by a user at the anchor end (such as an anchor) via a handle, or a controller, or a pulley control application installed at the anchor end, so that the cameras installed on the pulleys are driven to move, and the shooting of live broadcast pictures is realized.

Step 403, displaying the live broadcast picture.

In this embodiment, when there are a plurality of camera positions, the audience may also select by the audience end the live broadcast screen shot by the camera installed on the pulley at the corresponding camera position. For example, there are three camera positions in the broadcasting room: a camera position I, a camera position II and a camera position III. In case that the audience end has the control authority of the pulley at the camera position I, and the audience at the audience end selects to watch the live broadcast pictures shot by the cameras installed on the pulleys at the camera position I and the camera position II, the audience end may simultaneously acquire the live broadcast pictures shot by the cameras installed on the pulleys at the camera position I and the camera position II by the server; and the audience end may switch the display of the live broadcasting pictures of the two camera positions or display the live broadcasting pictures of the two camera positions side by side on the live broadcasting interface of the audience end.

According to the above technical solution, a control mode for enabling an audience to control a camera to shoot a live broadcast picture is provided, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

The method for controlling live broadcast provided by the embodiment of the present disclosure is described below in a specific application scene. Referring to FIG. 7, for example, an anchor end is provided with a pulley, the pulley is arranged on an elliptical track, and the elliptical track is arranged horizontally (of course, the elliptical track may also be arranged vertically depending on specific requirements). An anchor may be located within the elliptical track, and a camera 1 is installed on the pulley. The anchor opens the control authority of the pulley, and an audience end A, an audience end B and an audience end C participate in the competition of the control authority of the pulley, the result is that the audience end C obtains the control authority of the pulley, and the audience holding the audience end C may control the movement of the pulley by the pulley control application program installed on the audience end C to drive the camera 1 to move and shoot the anchor so as to obtain a live broadcast picture. Meanwhile, the camera 2 with a fixed camera position may also shoot the live broadcast picture of the anchor, the live broadcast pictures shot by the camera 1 and the camera 2 may be uploaded to the server by the anchor end, and the server may respectively forward the live broadcast pictures shot by the camera 1 and the camera 2 to the audience end A, the audience end B and the audience end C. Of course, the server may also forward the live broadcast pictures shot by the cameras of their own selected camera positions to the audience end A, the audience end B, and the audience end C according to actual requirements of the audience end A, the audience end B, and the audience end C, which will not be specifically limited here.

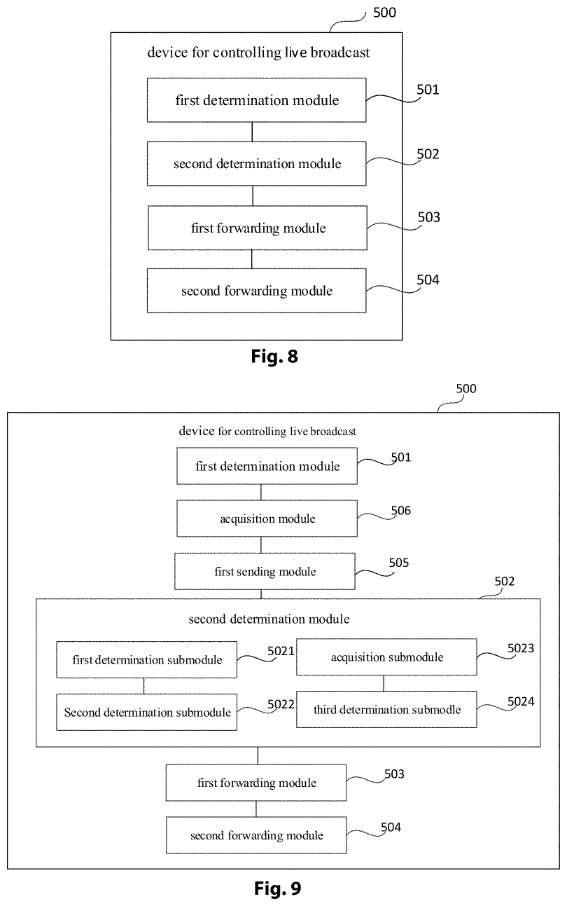

FIG. 8 is a structure diagram illustrating a device for controlling live broadcast 500 according to an embodiment of the present disclosure, the device for controlling live broadcast 500 may be applied to a server, the device for controlling live broadcast 500 comprises:

a first determination module 501 configured to determine a pulley with open control authority, wherein the pulley is arranged on a track, a camera is installed on the pulley, and the camera moves along with the pulley moving on the track;

a second determination module 502 configured to determine a target audience end with the control authority of the pulley;

a first forward module 503 configured to receive a control instruction sent by the target audience end for controlling movement of the pulley, and forwarding the control instruction to the pulley;

a second forward module 504 configured to receive a live broadcast picture shot by the camera, and forwarding the live broadcast picture to the target audience end.

In an embodiment, as shown in FIG. 9, the second determination module 502 comprises:

a first determination submodule 5021 configured to determine an audience end selected by an anchor;

a second determination submodule 5022 configured to determine the audience end selected by the anchor as the target audience end.

In an embodiment, as shown in FIG. 9, the second determination module 502 comprises:

an acquisition submodule 5023 configured to acquire authority competition rules set by an anchor;

a third determination submodule 5024 configured to determine the target audience end according to the authority competition rules.

In an embodiment, as shown in FIG. 9, the device 500 further comprises:

a first sending module 505 configured to send shooting elements of the camera installed on the pulley to each audience end in a broadcasting room, so that each audience end determines whether to participate in competition of the control authority of the pulley according to the shooting elements;

a third determination module 5024 specifically configured to determine the target audience end according to the authority competition rules.

In an embodiment, as shown in FIG. 9, the device 500 further comprises:

an acquisition module 506 configured to acquire an open time period of the control authority of the pulley set by the anchor;

the first forward module 503 specifically configured to receive a control instruction sent by the target audience end for controlling the pulley, and forwarding the control instruction to the pulley.

In an embodiment, the control instruction is used for controlling at least one of: a moving direction, a moving speed, a moving angle and a moving distance of the pulley.

It is obvious to those skilled in the art that, for convenience and simplicity of description, the foregoing division of each functional module is merely used as an example, and in practical applications, the above function distribution may be performed by different functional modules as needed, that is, the internal structure of the device is divided into different functional modules to perform all or part of the above described functions. For the specific working process of the functional module, reference may be made to the corresponding process in the foregoing method embodiment, which is not described herein again.

According to the above technical solution, a camera is installed on a pulley, the pulley is arranged on a track, the camera moves along with the pulley moving on the track, and control authority of the pulley is open; the technical solution comprises: determining a target audience end with the control authority of the pulley, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to the embodiment of the present disclosure, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

FIG. 10 is a structure diagram illustrating still another device for controlling live broadcast 600 applied to a terminal according to an embodiment of the present disclosure, the device for controlling live broadcast 600 comprises:

a second sending module 601 configured to send by a server, a control instruction for controlling movement of the pulley to the pulley, wherein the pulley is arranged on a track, a camera is installed on the pulley, and the camera moves along with the pulley moving on the track;

a receiving module 602 configured to receive by the server, a live broadcast picture shot by the camera;

a display module 603 configured to display the live broadcast picture.

According to the above technical solution, a control mode for enabling an audience to control a camera to shoot a live broadcast picture is provided, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

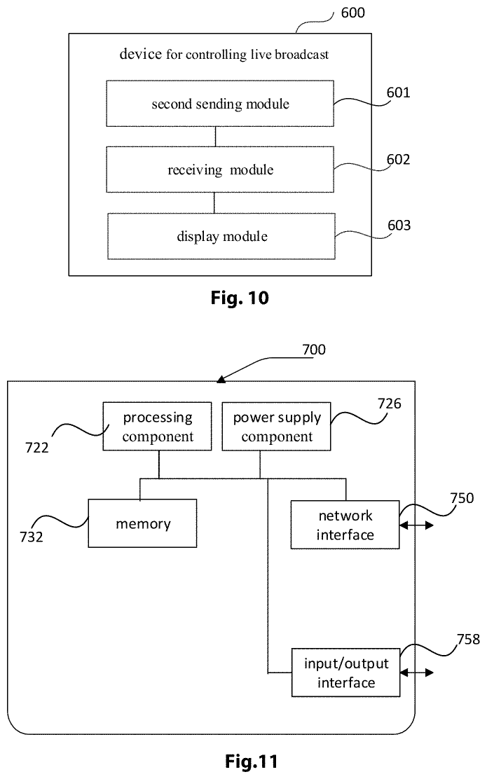

FIG. 11 is a structure diagram illustrating a device for controlling live broadcast according to an embodiment of the present disclosure. For example, the device 700 may be provided as a server. Referring to FIG. 11, the device 700 includes a processing component 722, which further includes one or more processor, and memory resources, represented by memory 732, for storing instructions executable by a processing component 722, e.g. application programs. The computer program stored in the memory 732 may include one or more modules each corresponding to a group of instructions. In addition, the processing component 722 is configured to execute the instructions to execute the method for controlling live broadcast described in FIG. 1, FIG. 2 or FIG. 4.

The device 700 may further include a power supply component 726, a wired or wireless network interface 750 and an input/output (I/O) interface 1958, the power supply component 726 is configured to execute power supply management of the device 700, and the wired or wireless network interface 750 is configured to connect the device 700 to network. The device 700 may operate based on an operating system stored in the memory 732, such as Windows Server™, Mac OS X™, Unix™, Linux™, FreeBSD™ and the like.

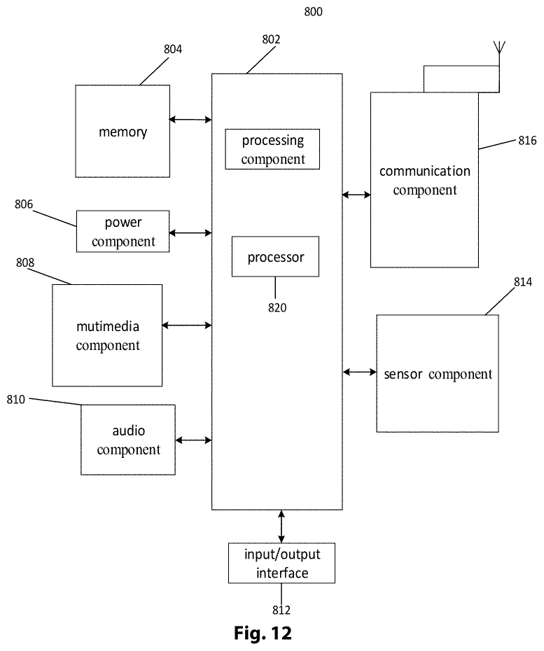

FIG. 12 is a structure diagram illustrating another device for controlling live broadcast according to an embodiment of the present disclosure. For example, the device 800 may be a mobile phone, a computer, a messaging device, a game console, a tablet device, a personal digital assistant, and the like.

Referring to FIG. 12, the device 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operations of the device 800, such as operations associated with display, telephone calls, data communications, camera operations, and recording operations. The processing component 802 may include one or more processors 820 to execute instructions to complete all or part of the steps of the method for controlling live broadcast shown in FIG. 6. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support operations in the device 800. Examples of such data include instructions for any application or method operating on the device 800, contact data, phone book data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the device 800. The power component 806 may include a power management system, one or more power supplies, and other components associated with generating, managing, and distributing power for the device 800.

The multimedia component 808 includes a screen that provides an output interface between the device 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of a touch or slide action, but also detect the duration and pressure related to the touch or slide operation. In some embodiments, the multimedia component 808 includes a front camera and/or a rear camera. When the device 800 is in an operation mode, such as a shooting mode or a video mode, the front camera and/or the rear camera may receive external multimedia data. Each of front camera and rear camera may be a fixed optical lens system or has focal length and optical zoom capabilities.

The audio component 810 is configured to output and/or input audio signals. For example, the audio component 810 includes a microphone (MIC), and when the device 800 is in an operation mode, such as a call mode, a recording mode, and a voice recognition mode, the microphone is configured to receive external audio signals. The received audio signal may be further stored in the memory 804 or transmitted via the communication component 816. In some embodiments, the audio component 810 further includes a speaker for outputting audio signals.

The I/O interface 812 provides an interface between the processing component 802 and a peripheral interface module. The peripheral interface module may be a keyboard, a click wheel, a button, and the like. These buttons may include but are not limited to: home button, volume button, start button, and lock button.

The sensor component 814 includes one or more sensors for providing the device 800 with various aspects of status assessment. For example, the sensor component 814 may detect the on/off status of the device 800 and the relative positioning of the components. For example, the component is the display and the keypad of the device 800. The sensor component 814 may also detect the position change of the device 800 or a component of the device 800, the presence or absence of contact between the user and the device 800, the orientation or acceleration/deceleration of the device 800, and the temperature change of the device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the device 800 and other devices. The device 800 may access a wireless network based on a communication standard, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the device 800 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors, or other electronic components to implement the method for controlling live broadcast shown in FIG. 6.

In an exemplary embodiment, there is also provided a non-transitory computer-readable storage medium including instructions, such as the memory 804 including instructions, which may be executed by the processor 820 of the device 800 to complete the method for controlling live broadcast shown in FIG. 6. For example, the non-transitory computer-readable storage medium may be ROM, random access memory (RAM), CD-ROM, magnetic tape, floppy disk, optical data storage device, etc.

In another exemplary embodiment, a computer program product is further provided, the computer program product includes a computer program that may be executed by a programmable device, and the computer program has code portions for performing the method for controlling live broadcast in the FIG. 1, FIG. 2, FIG. 4 or FIG. 6 described above when executed by the programmable device.

According to the technical solution provided by embodiments of the present disclosure, a camera is installed on a pulley, the pulley is arranged on a track, the camera moves along with the pulley moving on the track, and control authority of the pulley is open; the technical solution comprises: determining a target audience end with the control authority of the pulley, receiving a control instruction sent by the target audience end for controlling the movement of the pulley, and forwarding the control instruction to the pulley; and receiving a live broadcast picture shot by the camera, and forwarding the live broadcast picture to the target audience end. A control mode for enabling an audience to control a camera to shoot a live broadcast picture is provided according to the embodiment of the present disclosure, and the audience may control movement of the pulley on the track according to his own needs, so that the camera installed on the pulley is driven to move so as to control a shooting view angle, which meets the requirements for the audience to control the camera for live broadcast shooting, enhances the interestingness of the live broadcast, and improves the user experience.

Other embodiments of the present disclosure will be readily apparent to those skilled in the art from consideration of the description and practice of the present disclosure. This application is intended to cover any variations, uses, or adaptations of the present disclosure following the general principles of the present disclosure and including common general knowledge or customary technical means in the art not disclosed in the present disclosure. The description and embodiments are considered as exemplary only, with a true scope and spirit of the present disclosure being indicated by the following claims.

It should be understood that the present disclosure is not limited to the precise constructions described above and illustrated in the drawings, and that various modifications and variations may be made without departing from the scope thereof. The scope of the present disclosure is limited only by the appended claims.

1. A method for controlling live broadcast, applied to a server, the method for controlling live broadcast comprising:
determining a pulley with open control authority, wherein the pulley is arranged on a track, a camera is installed on the pulley, and the camera moves along with the pulley moving on the track;
determining a target audience end with the control authority of the pulley;
receiving a control instruction sent by the target audience end for controlling movement of the pulley, and forwarding the control instruction to the pulley; and
receiving a live broadcast picture shot by the camera, and forwarding the live broadcast picture to the target audience end.

2. The method for controlling live broadcast according to claim 1, wherein determining a target audience end with the control authority of the pulley comprises:
determining an audience end selected by an anchor; and
determining the audience end selected by the anchor as the target audience end.

3. The method for controlling live broadcast according to claim 1, wherein determining a target audience end with the control authority of the pulley comprises:
acquiring authority competition rules set by the anchor; and
determining the target audience end according to the authority competition rules.

4. The method for controlling live broadcast according to claim 3, wherein after determining a pulley with open control authority, further comprising:
sending shooting elements of the camera installed on the pulley to each audience end in a broadcasting room, so that each audience end determines whether to participate in competition of the control authority of the pulley according to the shooting elements;
determining the target audience end according to the authority competition rules, comprising:
selecting, according to the authority competition rules, the target audience end from the audience ends participating in the competition of the control authority of the pulley.

5. The method for controlling live broadcast according to claim 1, wherein before receiving a control instruction sent by the target audience end for controlling the pulley, and forwarding the control instruction to the pulley, further comprising:
acquiring an open time period of the control authority of the pulley set by the anchor;
receiving a control instruction sent by the target audience end for controlling the pulley, and forwarding the control instruction to the pulley, comprising:
receiving the control instruction sent by the target audience end for controlling the pulley, and forwarding the control instruction to the pulley during the open time period of the control authority.

6. The method for controlling live broadcast according to claim 1, wherein the control instruction is used for controlling at least one of: a moving direction, a moving speed, a moving angle and a moving distance of the pulley.

7. A method for controlling live broadcast, applied to a terminal, the method for controlling live broadcast comprising:
sending by a server, a control instruction for controlling movement of a pulley to the pulley, wherein the pulley is arranged on a track, a camera is installed on the pulley, and the camera moves along with the pulley moving on the track;
receiving by the server, a live broadcast picture shot by the camera; and
displaying the live broadcast picture.

8. A device for controlling live broadcast, applied to a server, comprising:
a memory having a computer program stored thereon; and
a processor configured to execute the computer program in the memory to implement a method for controlling live broadcast, and the method for controlling live broadcast comprises:
determining a pulley with open control authority, wherein the pulley is arranged on a track, a camera is installed on the pulley, and the camera moves along with the pulley moving on the track;
determining a target audience end with the control authority of the pulley;
receiving a control instruction sent by the target audience end for controlling movement of the pulley, and forwarding the control instruction to the pulley; and
receiving a live broadcast picture shot by the camera, and forwarding the live broadcast picture to the target audience end.

9. The device for controlling live broadcast according to claim 8, wherein determining a target audience end with the control authority of the pulley comprises:
determining an audience end selected by the anchor; and
determining the audience end selected by the anchor as the target audience end.

10. The device for controlling live broadcast according to claim 8, wherein determining a target audience end with the control authority of the pulley comprises:
acquiring authority competition rules set by the anchor; and
determining the target audience end according to the authority competition rules.

11. The device for controlling live broadcast according to claim 10, wherein after determining a pulley with open control authority, the method for controlling live broadcast further comprises:
sending shooting elements of the camera installed on the pulley to each audience end in a broadcasting room, so that each audience end determines whether to participate in competition of the control authority of the pulley according to the shooting elements;
determining the target audience end according to the authority competition rules, comprising:
selecting, according to the authority competition rules, the target audience end from the audience ends participating in the competition of the control authority of the pulley.

12. The device for controlling live broadcast according to claim 8, wherein before receiving a control instruction sent by the target audience end for controlling the pulley, and forwarding the control instruction to the pulley, the method for controlling live broadcast further comprises:
acquiring an open time period of the control authority of the pulley set by the anchor;
receiving a control instruction sent by the target audience end for controlling the pulley, and forwarding the control instruction to the pulley, comprising:
receiving the control instruction sent by the target audience end for controlling the pulley, and forwarding the control instruction to the pulley during the open time period of the control authority.

13. The device for controlling live broadcast according to claim 8, wherein the control instruction is used for controlling at least one of: a moving direction, a moving speed, a moving angle and a moving distance of the pulley.

14. The device for controlling live broadcast, applied to terminal, comprising:
a memory having a computer program stored thereon; and
a processor configured to execute the computer program in the memory to implement the steps of the method for controlling live broadcast of claim 7.

15. A computer readable storage medium having computer program instructions stored thereon, wherein the program instructions when are executed by a processor, implement the steps of the method for controlling live broadcast of claim 1.

16. A computer readable storage medium having computer program instructions stored thereon, wherein the program instructions when are executed by a processor, implement the steps of the method for controlling live broadcast of claim 7.
